(19) United States
(12) Patent Application Publication
(10) Pub. No.: US 2026/0127846 A1
(43) Pub. Date: May 7, 2026

(54) SPECULAR OBJECT DETECTION METHOD AND SYSTEM BASED ON FUSION OF MONO-PHASE MEASUREMENT DEFLECTOMETRY AND HAPTIC PERCEPTION

(71) Applicant: SOUTHEAST UNIVERSITY, Jiangsu (CN)

(72) Inventors: Aiguo SONG, Jiangsu (CN); Huiran HU, Jiangsu (CN); Yuzhen XIE, Jiangsu (CN); Huijun LI, Jiangsu (CN)

(73) Assignee: SOUTHEAST UNIVERSITY, Jiangsu (CN)

(21) Appl. No.: 19/315,789

(22) Filed: Sep. 1, 2025

Related U.S. Application Data
(63) Continuation of application No. PCT/CN2024/131915, filed on Nov. 14, 2024.

(30) Foreign Application Priority Data
Nov. 6, 2024 (CN) 202411575905.1

(51) Int. Cl. G06V 10/60; G01B 11/24; G06V 10/25; G06V 10/26

(52) U.S. Cl. CPC G06V 10/60; G01B 11/24; G06V 10/25; G06V 10/26

(57) ABSTRACT

A specular object detection method and system based on the fusion of mono-phase measurement deflectometry and haptic perception. Through a mono-phase measurement deflectometry (PMD) system, a sinusoidal fringe pattern having a fixed phase shift is projected onto a surface of the specular object. A camera captures the deformation of the fringe pattern reflected by the specular surface to obtain relative surface height information. A force sensor is configured to directly detect absolute height values at key points, thereby overcoming the problem that the mono-PMD can only provide relative height information and suffers from the ambiguity between height and gradient. A polynomial fitting method is adopted to fuse the relative height data obtained from visual detection with data of the absolute height obtained from the haptic detection, thereby reconstructing three-dimensional morphology of the entire object.

### CROSS-REFERENCE TO RELATED APPLICATION

This application is a continuation of international application of PCT application serial no. PCT/CN2024/131915 filed on Nov. 14, 2024, which claims priority benefit of China application no. 202411575905.1 filed on Nov. 6, 2024. The entirety of each of the above-mentioned patent applications is hereby incorporated by reference herein and made a part of this specification.

### BACKGROUND

### Technical Field

The present disclosure belongs to the technical field of high reflective surface recognition and detection, and in particular to a specular object detection method and system based on the fusion of mono-phase measurement deflectometry and haptic perception.

### Description of Related Art

With the rapid development of robotics, an increasing number of complex, high-precision, and highly repetitive tasks in areas such as industrial welding, surgery, and inspection are gradually being performed by robots. When performing tasks, robots must first rely on their perception of the environment, which is crucial for successful completion of the tasks. By enhancing the robots' sensing capabilities (such as vision, touch, and hearing), they can gain a better understanding of and adapt to their environments. In particular, in the measurement of three-dimensional (3D) morphology, the combination of vision and touch is especially critical.

However, with the advancement of precision manufacturing technology and the growing demands for product surface quality, an increasing number of highly reflective, mirror-like surfaces, such as mirrors, machined component surfaces, optical reflective mirrors, and polished materials, have emerged in industrial, optical, medical, and aerospace fields. These highly reflective surfaces impose greater requirements on visual perception of robots. Traditional visual detection systems are mostly optimized for surface with diffuse reflection. In these cases, the reflected light is evenly dispersed, and placement and angle of a camera or an optical detector do not need special consideration. Although these surfaces with diffuse reflection may have highly reflective regions, current high dynamic range (HDR) technology can effectively address the cases by adjusting the camera's exposure time.

Typical visual detection techniques are generally based on triangulation methods, such as binocular vision and structured light techniques. These methods have been widely applied in industrial scenarios and offer high measurement stability and performance. However, for highly reflective mirror surfaces, the reflected light is constrained by the surface normal and propagates according to strict optical laws, which poses a significant challenge to visual detection systems, and results in inaccurate positioning or even erroneous recognition. A traditional solution is to spray a developing agent on a mirror surface to create diffuse reflection. Although this method improves measurement performance, the spraying process before each measurement is cumbersome and inefficient. Another method is haptic detection, which is unaffected by the optical properties of the surface. However, this point-by-point contact method is also inefficient, produces sparse data, and cannot obtain full-field 3D information.

To address this problem, researchers have proposed various solutions. For example, Petz et al. measured mirror surfaces using parallel grating imaging; Savarese et al. analyzed the relationship between geometric imaging and surface morphology in mirrors; Knauer et al. proposed monocular phase measurement deflectometry (Mono-PMD) for measuring highly reflective freeform surfaces. However, Mono-PMD suffers from the ambiguity between gradient and height. As shown in FIG. 1, Point O1 on a mirror reflects Point A on a display screen onto a camera. When the mirror only deflects by an angle of β, Point A in the camera image changes to Point C. When the mirror shifts by a height h, Point A in the camera image changes to Point B. The reflection of the same pixel point in the camera from Point A may be similarly affected by either the gradient or the height of the mirror surface. Therefore, it is impossible to accurately determine whether a phase change is caused by the height of the highly reflective surface or by the surface gradient. Although stereo phase measurement deflectometry (Stereo-PMD) combines binocular vision to overcome some limitations, it requires extremely robust pixel matching and precise system calibration. Some monocular PMD-based systems achieve 3D measurement of discontinuous mirror surfaces through specific optical path combinations. After extensive research, PMD technology has proven effective for measuring highly reflective surfaces; however, its core challenge, the ambiguity between gradient and height, has not yet been completely resolved. In addition, the accuracy of PMD systems heavily relies on the calibration process, which remains a challenge for PMD systems.

### SUMMARY

In order to addresses the limitations of traditional visual detection systems in detecting highly reflective mirrored objects, the present disclosure provides a specular object detection method and system based on the fusion of mono-phase measurement deflectometry and haptic perception. Through a mono-phase measurement deflectometry (PMD) system, a fringe pattern with a fixed phase shift is projected onto a surface of the specular object. A camera captures the fringe deformation in a specular region to obtain relative surface height information. A force sensor is configured to directly detect absolute heights at key points, thereby overcoming the problem that the mono-PMD can only provide relative height information and suffers from the ambiguity between height and gradient. Based on the absolute height data obtained from the force sensor, a polynomial fitting method is adopted to fuse the relative height data obtained from visual detection with data of the absolute height obtained from the haptic detection, thereby reconstructing three-dimensional morphology of the entire object. The method of the present disclosure effectively solves the ambiguity of height and gradient, and improves the accuracy and efficiency of three-dimensional reconstruction through polynomial fitting

In order to achieve the above objectives, one technical solution adopted by the present disclosure is: a specular object detection method based on the fusion of mono-phase measurement deflectometry and haptic perception, including the following steps:
S1. recognizing a specular region: capturing a reflection image of a specular object using a camera to recognize a specular region;
S2. acquiring phase information: acquiring phase information of a surface of the specular object by phase measurement deflectometry (PMD), where the phase information includes at least phase gradient data;
S3. performing phase unwrapping and gradient calculation: unwrapping the phase information obtained in the step S2 using a quality-guided phase unwrapping algorithm, and performing gradient calculation;
S4. calculating a relative height: reconstructing a relative height of the specular object according to the phase gradient data using an integration method;
S5. acquiring an absolute height by haptic detection: performing absolute height measurement using a force sensor, and performing conversion to obtain a height in a world coordinate system;
S6. performing vision-haptics fusion: fusing data of the relative height obtained in the step S4 with data of the absolute height obtained in the step S5, use the least squares method to obtain polynomial coefficients, and use polynomial formulas to obtain the overall three-dimensional shape of the mirror object surface;
S7. outputting three-dimensional height data: outputting the fused 3D height data to generate 3D morphology information of the specular object and completing the detection of the specular object.

As an improvement of the present disclosure, the step S1 specifically includes the following sub-steps:
S11. adjusting shooting angles of a display screen and a camera, and capturing a display screen frame through the specular region, where the display screen frame includes two images, that is, a pure black image and a pure white image;
S12: performing a pixel difference operation on the pure black image and the pure white image obtained in the step S11 to obtain a difference image:

$${I}_{diff} = \vert {I}_{white} - {I}_{black} \vert ,$$

where I_{white} and I_{black} respectively represent grayscale values of images captured by the camera when the display screen displays the pure white image and the pure black image;
S13: performing binarization on the difference image obtained in the step S12 using an Otsu algorithm (OTSU) to accurately recognize the specular region.

As an improvement of the present disclosure, the step S2 specifically includes: in the specular region recognized in the step S1, a Mono-PMD system is used to project a sinusoidal fringe pattern having a fixed phase difference onto the surface of the specular object, and the camera is configured to capture reflected images of fringe patterns on the surface of the specular object and acquire phase gradient data; and specific forms of the fringe patterns displayed on the display screen and the phase calculation formula are as follows:

$$\begin{matrix}{I}_{n} ( x , y ) = {I}_{0} + A ( x , y ) sin ( ϕ ( x , y ) + 2 n π / N ) , \\ ϕ ( x , y ) = arc tan ( \frac{{I}_{4} ( x , y ) - {I}_{2} ( x , y )}{{I}_{1} ( x , y ) - {I}_{3} ( x , y )} ) ,\end{matrix}$$

where I₀ denotes a base light intensity of the display screen, A(x, y) denotes a modulation light intensity, φ(x, y) denotes a phase value at this location, N denotes a total number of phase shift steps, and n denotes a number of current phase shift steps.

As an improvement of the present disclosure, the step S3 specifically includes: a phase difference Δφ(x, y) is obtained by subtracting measured results of a reference planar mirror from a measured phase of a freeform mirror, and gradients gₓ and g_{y} of the phase difference in x and y directions are respectively calculated as follows:

$$\{ \begin{matrix}Δϕ ( x , y ) = {ϕ}_{m} ( x , y ) - {ϕ}_{r} ( x , y ) \\ {g}_{x} = \frac{Δ ϕ ( x + 1 , y ) - Δ ϕ ( x , y )}{dx} \\ {g}_{y} = \frac{Δ ϕ ( x , y + 1 ) - Δ ϕ ( x , y )}{dy}\end{matrix} ,$$

where φₘ(x, y) denotes the measured phase, and φᵣ(x, y) denotes a reference phase.

As an improvement of the present disclosure, the step S4 specifically includes: a central point in a region of interest (ROI) is selected as a reference point, a single integration is performed on gradient data in the x and y directions to obtain relative heights along reference lines; and results of the integration are taken as starting points to perform integration over the entire ROI, and to reconstruct relative three-dimensional height data of the entire specular object:

$${Z}_{visual} ( x , y ) = {Z}_{0} ( x , y ) + {\int }_{- x}^{x} ( {g}_{x} + {g}_{y} ) dx + {\int }_{- y}^{y} ( {g}_{x} + {g}_{y} ) dy ,$$

where Z₀(x, y) denotes an initial reference point, and gₓ and g_{y} denote gradients of phase differences in x and y directions, respectively.

As an improvement of the present disclosure, a method for performing conversion to obtain a height in a world coordinate system in the step S5 is as follows:

$${P}_{world} = {T}_{arm 1}^{base} {T}_{arm 2}^{arm 1} … {T}_{tool}^{end point} {P}_{tool} ,$$

where P_{world}=(X_{world}, Y_{world}, Z_{world}) is coordinates in the world coordinate system; Pₜₒₒₗ=(Xₜₒₒₗ, Yₜₒₒₗ, Zₜₒₒₗ) is a position of a current contact point in the tool coordinate system when a measurement unit of the force sensor exceeds a preset threshold; and

$$( {T}_{arm 1}^{base} , {T}_{arm 2}^{arm 1} , … , {T}_{armn}^{armn - 1} )$$

denotes a coordinate system transformation relationship among joints of a current robotic arm.

As another improved solution of the present disclosure, the polynomial fitting formula in the step S6 is as follows:

$${Z}_{world} = {\sum }_{k = 0}^{K} {A}_{k} {Z}_{visual}^{k} ,$$

where k denotes a polynomial order, K denotes a total number of polynomial terms, Aₖ denotes a polynomial coefficient, and Zᵥᵢₛᵤₐₗ denotes a relative height obtained by integrating the phase difference.

In order to achieve the above objectives, another technical solution adopted by the present disclosure is to provide a specular object detection system based on the fusion of mono-phase measurement deflectometry and haptic perception, including a computer program, and when the computer program is executed by a processor, the steps of any one of the above methods are implemented.

Compared with the prior art, the present disclosure has the following beneficial effects:
(1) Overcoming the ambiguity problem: The method of the present disclosure combines phase measurement deflectometry with haptic perception to solve the ambiguity between height and gradient inherent in traditional PMD methods, thereby achieving accurate three-dimensional detection of objects with highly reflective surfaces.
(2) Improved detection accuracy: By fusing visual relative height and haptic absolute height, the method of the present disclosure ensures the completeness and accuracy of the detection data, reducing the errors encountered by traditional visual systems on objects with highly reflective surfaces.
(3) Enhanced detection efficiency: The method of the present disclosure adopts PMD technology to quickly acquire phase information, which significantly improves the acquisition speed compared with traditional point-by-point haptic detection. In addition, the fusion process compensates for the sparsity of haptic data.
(4) Increased system robustness: Since the system no longer relies on complex calibration procedures and provides an absolute height reference using haptic data, it enables stable and accurate detection performance in various complex environments.
(5) Wide applicability: The method and system of the present disclosure are particularly suitable for high-precision detection in industrial, optical, and aerospace fields, and can provide accurate three-dimensional surface morphology data for applications such as robotic operation and precision machining.

### BRIEF DESCRIPTION OF THE DRAWINGS

FIG. 1 is a schematic diagram of measurement principles of Mono-PMD in the prior art.

FIG. 2 is a schematic diagram of measurement principles for acquiring an absolute height through by haptic detection in a step S5 according to the present disclosure.

FIG. 3 is a flowchart of a visual-haptic fusion process in a step S6 according to the present disclosure.

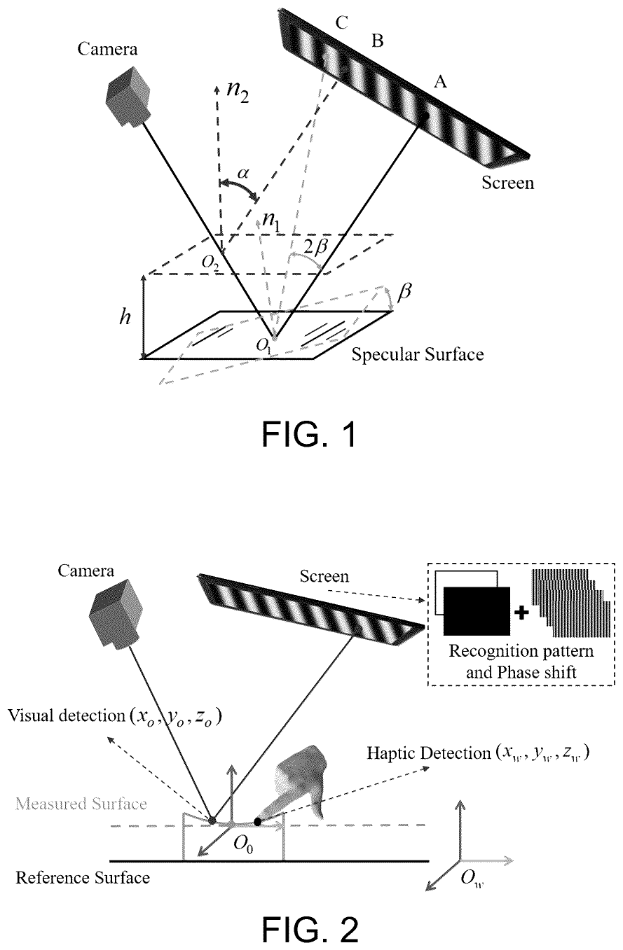

### DESCRIPTION OF THE EMBODIMENTS

The present disclosure will be further illustrated below with reference to the accompanying drawings and specific embodiments. It should be understood that the following specific embodiments are only used to illustrate the present disclosure, but are not intended to limit the scope of the present disclosure.

### Embodiment 1

A specular object detection method based on the fusion of mono-phase measurement deflectometry and haptic perception is provided. By integrating vision and haptic perception, the method effectively addresses the limitations of using a single modality in detecting highly reflective surfaces, thereby not only improving measurement accuracy but also enhancing the stability and adaptability of the system. The method includes the following steps:

### Step S1. Recognizing a Specular Region:

adjusting shooting angles of a display screen and a camera to enable a camera to be capable of capturing a complete or partial image of the display screen through a specular region, displaying a pure black image and a pure white image through the display screen, and capturing a reflection image of the specular object using the camera. A pixel difference operation is performed on the pure black image and the pure white image to obtain a difference image, as shown in Formula (1):

$${I}_{diff} = \vert {I}_{white} - {I}_{black} \vert , \qquad ( 1 )$$

where I_{white} and I_{black} respectively represent grayscale values of images captured by the camera when the display screen displays the pure white image and the pure black image.

Subsequently, the difference image is binarized using an Otsu algorithm (OTSU) to accurately recognize the specular region and provide a basis for subsequent phase extraction and unwrapping processing.

### Step S2. Acquiring Phase Information:

acquiring phase information of a surface of the specular object by phase measurement deflectometry (PMD). With the cooperation of the camera and the display screen, sinusoidal fringe patterns having a fixed phase difference are projected onto the object surface. The camera captures the reflected fringe images from the surface of the specular object and acquires phase gradient data.

Within the recognized specular region, a Mono-PMD system is used to project a sinusoidal fringe pattern having a fixed phase difference onto the surface of the specular object. The camera is configured to capture reflected images of fringe patterns on the surface of the specular object. Phase information is calculated from four phase-shifted images with different phases using a phase-shifting technique. Phase values are calculating using an arctangent function, and phase gradient data is thereby obtained. Specific forms of the fringe patterns displayed on the display screen and the phase calculation formula are shown in Formulae (2) and (3):

$${I}_{n} ( x , y ) = {I}_{0} + A ( x , y ) sin ( ϕ ( x , y ) + 2 n π / N ) , \qquad ( 2 )$$

$$ϕ ( x , y ) = arctan ( \frac{{I}_{4} ( x , y ) - {I}_{2} ( x , y )}{{I}_{1} ( x , y ) - {I}_{3} ( x , y )} ) . \qquad ( 3 )$$

### Step S3. Performing Phase Unwrapping and Gradient Calculation:

unwrapping the acquired phase data using a quality-guided phase unwrapping algorithm to ensure the continuity of the phase data and eliminate errors caused by phase jumps.

Since the phase calculated results obtained in Formula (3) are wrapped in a range of [−π, π), phase unwrapping is required. Phase data in a region of interest (ROI) is unwrapped using the quality-guided phase unwrapping algorithm to obtain a continuous phase distribution and eliminate phase jumps. The unwrapped phase data is then used to further calculate a relative height of the specular object.

A phase difference Δφ(x, y) is obtained by subtracting measured results of a reference planar mirror from a measured phase of a freeform mirror, and gradients gₓ and g_{y} of the phase difference in x and y directions are respectively calculated as follows:

$$\{ \begin{matrix}Δ ϕ ( x , y ) = {ϕ}_{m} ( x , y ) - {ϕ}_{r} ( x , y ) \\ {g}_{x} = \frac{Δ ϕ ( x + 1 , y ) - Δ ϕ ( x , y )}{dx} , \\ {g}_{y} = \frac{Δ ϕ ( x , y + 1 ) - Δ ϕ ( x , y )}{dy}\end{matrix} \qquad ( 4 )$$

where φₘ(x, y) denotes the measured phase, and φᵣ(x, y) denotes a reference phase.

### Step S4. Calculating a Relative Height:

reconstructing a relative height of the specular object according to the phase gradient data using an integration method.

A central point in the ROI is selected as a reference point based on the unwrapped phase difference gradient data. The gradient data in the x and y directions are first integrated along reference lines to obtain relative heights along the reference lines. Results of the integration are taken as starting points to perform integration over the entire ROI, and to reconstruct relative three-dimensional height data of the entire specular object, as shown in Formula (5):

$${Z}_{visual} ( x , y ) = {Z}_{0} ( x , y ) + {\int }_{- x}^{x} ( {g}_{x} + {g}_{y} ) dx + {\int }_{- y}^{y} ( {g}_{x} + {g}_{y} ) dy . \qquad ( 5 )$$

### Step S5. Acquiring an Absolute Height by Haptic Detection:

performing absolute height measurement using a force sensor; obtaining absolute height information using a force sensor on a robotic arm in contact with the surface of the specular object, and converting the absolute height information into a height in a world coordinate system through kinematic modeling, as shown in FIG. 2.

The force sensor on the robotic arm is configured to perform haptic detection of the specular object. The force sensor on the robotic arm is configured to record the height data when it touches the surface of the specular object as absolute height information. The specific operation is as follows: the robotic arm is controlled to touch a highly reflective surface through remote control under observation through the camera, when force measured by the force sensor on the robotic arm exceeds a preset threshold, a position Pₜₒₒₗ=(Xₜₒₒₗ, Yₜₒₒₗ, Zₜₒₒₗ) of the tool coordinate system where the current touch point is located, and the coordinate system transformation relationship

$$( {T}_{arm 1}^{base} , {T}_{arm 2}^{arm 1} , … , {T}_{armn}^{armn - 1} )$$

among joints of a current robotic arm, are recorded. The position of the contact point is then converted to the world coordinate system P_{world}=(X_{world}, Y_{world}, Z_{world}) through kinematic modeling, with the calculation formula shown in Formula (6):

$${P}_{world} = {T}_{arm 1}^{base} {T}_{arm 2}^{arm 1} … {T}_{tool}^{endpoint} {P}_{tool} . \qquad ( 6 )$$

### Step S6. Performing Vision-Haptics Fusion:

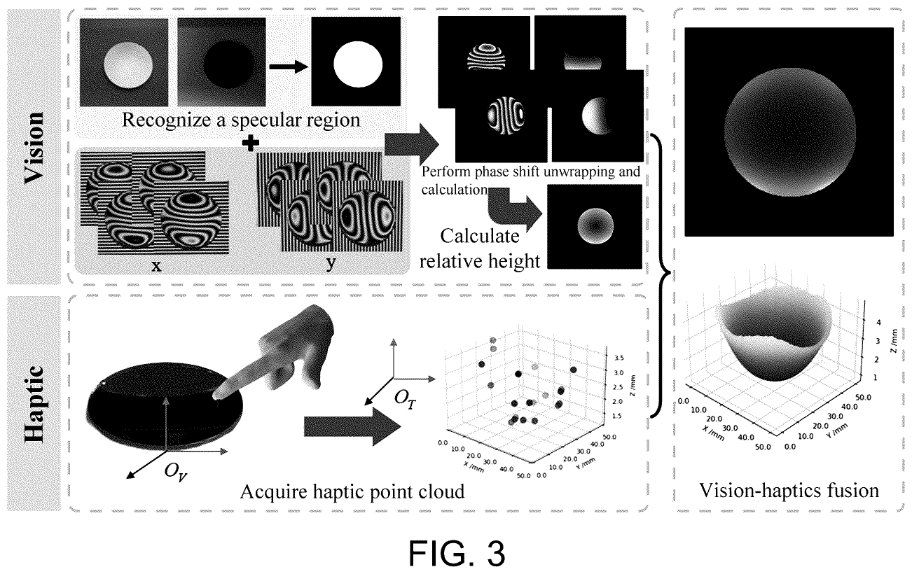

fusing the relative height data obtained from visual detection with the absolute height data from force sensor; and fitting a polynomial using a least squares method, combining the visual relative height and the haptic absolute height to obtain an overall three-dimensional morphology of the specular object, as shown in FIG. 3.

In order to avoid redundant recordings of the same contact point or contact points that are too close, a contact point is not recorded when its distance to any existing contact point does not exceed a predefined storage threshold. After data acquisition is completed, all recorded contact points form a haptic point cloud, and height values Z_{world} in the haptic point cloud are extracted. Polynomial coefficients are fitted using the absolute height points from the force sensor by the least squares method, and the relative height data obtained from visual detection is fused with data of the absolute height obtained from the haptic detection. The absolute three-dimensional surface of the specular object in the world coordinate system is finally calculated using a polynomial fitting formula: The formula is shown in Formula (7) as follows.

$${Z}_{world} = {\sum }_{n = 0}^{N} {A}_{n} {Z}_{visual}^{n} , \qquad ( 7 )$$

where n denotes a polynomial order, and Aₙ denotes a polynomial coefficient.

### Step S7. Outputting Three-Dimensional Height Data:

outputting the fused three-dimensional height data after data fusion. The fused three-dimensional height data reflects an actual surface morphology of the specular object, thereby completing the detection of the specular object. The resulting information can be applied in scenarios such as high-precision detection, and surface analysis.

Through the above steps, the present disclosure can effectively combine visual information and haptic information, overcoming the limitations of traditional methods in detecting highly reflective surfaces and improving the accuracy of three-dimensional surface reconstruction of the specular object.

In summary, the method and system of the present disclosure overcome the ambiguity of height and gradient in the detection of highly reflective specular objects by the traditional visual detection systems. The present disclosure also effectively addresses the difficulty of accurately capturing the three-dimensional morphology of highly reflective surfaces due to their optical complexity. Although a single haptic detection method can provide absolute height information, the data is sparse and acquisition efficiency is low, making it impossible to completely reconstruct the three-dimensional morphology of the entire object. The method of the present disclosure combines visual detection and haptic detection through a fusion technique to solve the ambiguity of height and gradient, and further improves the accuracy and efficiency of three-dimensional reconstruction through polynomial fitting. Moreover, the method enhances stability and adaptability of the system, making it suitable for industrial, optical, medical, and other applications requiring high-precision detection of surface of the specular object.

It should be noted that the above content merely illustrates the technical idea of the present disclosure and cannot limit the protection scope of the present disclosure, those ordinarily skilled in the art may also make some modifications and improvements without departing from the principle of the present disclosure, and these modifications and improvements should also fall within the protection scope of the claims of the present disclosure.

What is claimed is:

1. A specular object detection method based on fusion of mono-phase measurement deflectometry and haptic perception, comprising following steps:
step S1: recognizing a specular region: capturing a reflection image of a specular object using a camera to recognize a specular region;
step S2: acquiring phase information: acquiring phase information of a surface of the specular object by phase measurement deflectometry (PMD), wherein the phase information comprises at least phase gradient data;
step S3: performing phase unwrapping and gradient calculation: unwrapping the phase information obtained in the step S2 using a quality-guided phase unwrapping algorithm, and performing gradient calculation;
step S4: calculating a relative height: reconstructing a relative height of the specular object according to the phase gradient data using an integration method;
step S5: acquiring an absolute height by haptic detection: performing absolute height measurement using a force sensor, and performing conversion to obtain a height in a world coordinate system;
step S6: performing vision-haptics fusion: fusing data of the relative height obtained in the step S4 with data of the absolute height obtained in the step S5, using a least squares method to obtain polynomial coefficients, and use polynomial formulas to obtain a overall three-dimensional shape of a mirror object surface;
step S7: outputting three-dimensional height data: outputting a fused three-dimensional (3D) height data to generate 3D morphology information of the specular object, and completing the detection of the specular object.

2. The specular object detection method based on the fusion of mono-phase measurement deflectometry and haptic perception according to claim 1, wherein the step S1 comprises following sub-steps:
S11: adjusting shooting angles of a display screen and the camera, and capturing a display screen frame through the specular region, wherein the display screen frame comprises a pure black image and a pure white image;
S12: performing a pixel difference operation on the pure black image and the pure white image obtained in the step S11 to obtain a difference image:
$${I}_{diff} = \vert {I}_{white} - {I}_{black} \vert ,$$
wherein I_{white} and I_{black} respectively represent grayscale values of images captured by the camera when the display screen displays the pure white image and the pure black image; and
S13: performing binarization on the difference image obtained in the step S12 using an Otsu algorithm (OTSU) to accurately recognize the specular region.

3. The specular object detection method based on the fusion of mono-phase measurement deflectometry and haptic perception according to claim 2, wherein the acquiring phase information in the step S2 is as follows: in the specular region recognized in the step S1, a monocular phase measurement deflectometry (Mono-PMD) system is used to project a sinusoidal fringe pattern having a fixed phase difference onto the surface of the specular object, and the camera is configured to capture reflected images of fringe patterns on the surface of the specular object and acquire phase gradient data; and specific forms of the fringe patterns displayed on the display screen and a phase calculation formula are as follows:
$${I}_{n} ( x , y ) = {I}_{0} + A ( x , y ) sin ( ϕ ( x , y ) + 2 n π / N ) ,$$
$$ϕ ( x , y ) = arctan ( \frac{{I}_{4} ( x , y ) - {I}_{2} ( x , y )}{{I}_{1} ( x , y ) - {I}_{3} ( x , y )} ) ,$$
wherein I₀ denotes a base light intensity of the display screen, A(x, y) denotes a modulation light intensity, φ(x, y) denotes a phase value at this location, N denotes a total number of phase shift steps, and n denotes a number of current phase shift steps.

4. The specular object detection method based on the fusion of mono-phase measurement deflectometry and haptic perception according to claim 3, wherein the performing gradient calculation in the step S3 is as follows: a phase difference Δφ(x, y) is obtained by subtracting measured results of a reference planar mirror from a measured phase of a freeform mirror, and gradients gₓ and g_{y} of the phase difference in x and y directions are respectively calculated as follows:
$$\{ \begin{matrix}Δ ϕ ( x , y ) = {ϕ}_{m} ( x , y ) - {ϕ}_{r} ( x , y ) \\ {g}_{x} = \frac{Δ ϕ ( x + 1 , y ) - Δ ϕ ( x , y )}{dx} , \\ {g}_{y} = \frac{Δ ϕ ( x , y + 1 ) - Δ ϕ ( x , y )}{dy}\end{matrix}$$
wherein φₘ(x, y) denotes the measured phase, and φᵣ(x, y) denotes a reference phase.

5. The specular object detection method based on the fusion of mono-phase measurement deflectometry and haptic perception according to claim 4, wherein in the step S4, a central point in a region of interest (ROI) is selected as a reference point, a single integration is performed on gradient data in the x and y directions to obtain relative heights along reference lines; and results of the integration are taken as starting points to perform integration over an entire ROI, and to reconstruct relative three-dimensional height data of an entire specular object:
$${Z}_{visual} ( x , y ) = {Z}_{0} ( x , y ) + {\int }_{- x}^{x} ( {g}_{x} + {g}_{y} ) dx + {\int }_{- y}^{y} ( {g}_{x} + {g}_{y} ) dy ,$$
wherein Z₀(x, y) denotes an initial reference point, and gₓ and g_{y} respectively denote gradients of phase differences in the x and y directions.

6. The specular object detection method based on the fusion of mono-phase measurement deflectometry and haptic perception according to claim 1, wherein in the step S5, a method for performing conversion to obtain a height in a world coordinate system in the step S5 is as follows:
$${P}_{world} = {T}_{arm 1}^{base} {T}_{arm 2}^{arm 1} … {T}_{tool}^{endpoint} {P}_{tool} ,$$
wherein P_{world}=(X_{world}, Y_{world}, Z_{world}) is coordinates in the world coordinate system; Pₜₒₒₗ=(Xₜₒₒₗ, Yₜₒₒₗ, Zₜₒₒₗ) is a position of a current contact point in a tool coordinate system when a measurement unit of the force sensor exceeds a preset threshold; and
$$( {T}_{arm 1}^{base} , {T}_{arm 2}^{arm 1} , … , {T}_{armn}^{armn - 1} )$$
denotes a coordinate system transformation relationship among joints of a current robotic arm.

7. The specular object detection method based on the fusion of mono-phase measurement deflectometry and haptic perception according to claim 1, wherein a polynomial fitting formula in the step S6 is as follows:
$${Z}_{world} = {\sum }_{k = 0}^{K} {A}_{k} {Z}_{visual}^{k} ,$$
wherein k denotes a polynomial order, K denotes a total number of polynomial terms, Aₖ denotes a polynomial coefficient, and Zᵥᵢₛᵤₐₗ denotes a relative height obtained by integrating a phase difference.

8. A specular object detection system based on the fusion of mono-phase measurement deflectometry and haptic perception, comprising a computer program, wherein when the computer program is executed by a processor, the steps of the methods according to claim 1 are implemented.
